(19) United States
(12) Patent Application Publication
(10) Pub. No.: US 2025/0278183 A1
(43) Pub. Date: Sep. 4, 2025

(54) DIGITAL MIXER

(71) Applicant: TEAC CORPORATION, Tokyo (JP)

(72) Inventor: Makoto SUGAYA, Tokyo (JP)

(21) Appl. No.: 19/052,016

(22) Filed: Feb. 12, 2025

(30) Foreign Application Priority Data
Mar. 4, 2024 (JP) 2024-032286

(51) Int. Cl. G06F 3/04847; G06F 3/0482

(52) U.S. Cl. CPC G06F 3/04847; G06F 3/0482

(57) ABSTRACT

A technique is provided that enables a user of a digital mixer to set multiple functions, including an AFV function, in response to input from one external control terminal. A processor of the digital mixer causes a display device to display, in response to setting of a setting mode of the external control terminal by an operator, a setting screen for function/parameter setting of the external control terminal; displays, in response to setting of an AFV function setting mode by the operator, an AFV trigger source selection screen for selection of ON/OFF of AFV function of each channel and selection of the external control terminal serving as a trigger source of AFV function of each channel; displays, on the setting screen, all functions already set for the external control terminal; and displays, on the AFV trigger source selection screen, the function already set for the external control terminal serving as the trigger source.

### CROSS REFERENCE TO RELATED APPLICATION

This application claims priority to Japanese Patent Application No. 2024-032286 filed on Mar. 4, 2024, which is incorporated herein by reference in its entirety including the specification, claims, drawings, and abstract.

### TECHNICAL FIELD

The present disclosure relates to a digital mixer or mixing console that performs processing for mixing audio signals, and in particular to settings of an audio follow video (AFV) function.

### BACKGROUND

Digital mixers process and output audio signals in response to signals from multiple input/output terminals and switches. However, it is usual that one function is set and activated in response to input from one external control terminal. For example, one function (e.g., Mute) is set for each of multiple general purpose input/outputs (GPIOs).

Meanwhile, it has been already proposed to equip digital mixers with the AFV function. Incorporating the AFV function enables automatic control of the fader level in response to an external tally input event. This can further improve the functionality and usability of digital mixers.

However, in the case of incorporating the AFV function, such a situation that multiple functions can be set in response to input from one external control terminal may arise.

JP 2016-206827 A discloses a print setting control program that makes it easy to check setting changes to be performed to resolve conflicts in setting and can perform print processing appropriately, although it is not related to the digital mixer. Specifically, the print setting control program operates on a device that instructs an image formation device to perform printing. The program causes the device to function as: an information acquisition unit configured to acquire information on functions that can be executed by the image formation device; a display control unit configured to cause a display unit to display a print setting screen for setting functions executable by the image formation device based on the acquired information; and a prohibition determination unit configured to determine whether pre-settings performed beforehand using the print setting screen conflict with post-settings performed later and, if there is any conflict in settings, change the pre-settings to settings that do not conflict with the post-settings. When the pre-settings have been changed due to the conflict in settings, the display control unit decorates the display at setting portions for the pre-settings and the post-settings.

However, in the digital mixer, when multiple functions are set in response to input from one external control terminal for the purpose of incorporating the AFV function, it is convenient from the standpoint of improving the operability to enable settings for both cases where the multiple functions are compatible and those where they are not, and to leave the determination to users regarding whether or not to make the settings valid.

### SUMMARY

The present disclosure intends to provide a technique that enables users of digital mixers to set multiple functions, including the AFV function, in response to input from one external control terminal, thereby supporting the users when setting the multiple functions.

A digital mixer of the present disclosure includes an external control terminal, a processor, a display device, and an operator. The processor causes the display device to display, in response to setting of a setting mode of the external control terminal by the operator, a setting screen for function/parameter setting of the external control terminal; causes the display device to display, in response to setting of an AFV function setting mode by the operator, an AFV trigger source selection screen for selection of ON/OFF of AFV function of each channel and the external control terminal serving as a trigger source of AFV function of each channel; displays, on the setting screen, all functions already set for the external control terminal; and displays, on the AFV trigger source selection screen, the function already set for the external control terminal serving as the trigger source.

As a result, when functions set for an external control terminal are focused on, the functions already set are displayed on the setting screen, and further the functions already set are displayed on the AFV trigger source selection screen. Therefore, users can visually check the setting status of multiple functions including the AFV function on either screen.

According to one aspect of the present disclosure, the processor may display, on the setting screen, a mark indicating the AFV function together with the function already set when the AFV function is set for the external control terminal, and may display, on the AFV trigger source selection screen, the mark indicating the AFV function together with the function already set when the AFV function is set for the external control terminal serving as the trigger source.

According to another aspect of the present disclosure, the processor may further display a mark indicating a channel for which the trigger source operates, in association with the mark indicating the AFV function on the setting screen.

According to yet another aspect of the present disclosure, the processor may further display, when the trigger source is for multiple channels, a list of the multiple channels according to an operation for selecting the mark indicating the AFV function.

According to the present disclosure, users of digital mixers can set multiple functions, including the AFV function, in response to input from one external control terminal, and accordingly supporting the settings of multiple functions by users is feasible.

### BRIEF DESCRIPTION OF DRAWINGS

Embodiment(s) of the present disclosure will be described based on the following figures, wherein:

FIG. 1 is a configuration block diagram illustrating a digital mixer according to an embodiment;

FIG. 2 is an external control terminal function setting flowchart according to an embodiment;

FIG. 3 is an AFV function setting flowchart according to an embodiment;

FIG. 4 illustrates an exemplary screen (Part 1);

FIG. 5 illustrates an exemplary screen (Part 2);

FIG. 6 illustrates an exemplary screen (Part 3);

FIG. 7 illustrates an exemplary screen (Part 4);

FIG. 8 illustrates an exemplary screen (Part 5);

FIG. 9 illustrates an exemplary screen for selecting a trigger source of AFV function;

FIG. 10 illustrates a variation of an exemplary screen (Part 1); and

FIG. 11 illustrates a variation of an exemplary screen (Part 2).

### DESCRIPTION OF EMBODIMENTS

### <Overall Configuration>

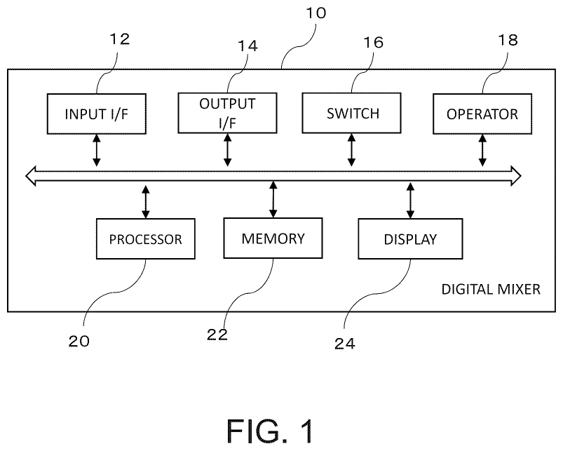

FIG. 1 is a configuration block diagram illustrating a digital mixer (or mixing console) 10 according to the present embodiment. The digital mixer 10 executes, for various input audio signals, routing processing, assignment processing, equalizing processing, mixing processing, effect processing, and the like, and outputs processed signals to the outside.

The digital mixer 10 has an external appearance whose configuration is roughly as follows. That is, the digital mixer 10 has a front surface mainly separated into a channel section and a master section. The channel section is equipped with a display for each channel module consisting of multiple channels, e.g., 8 channels, to display the status or the like of the channel module. Equipment for each channel of the channel module includes various channel operation buttons, such as MUTE, SOLO, and SEL operation buttons, and also includes operation faders. Further, the master section is equipped with various operation keys, such as a home key, a menu key, and a master fader. Equipment on the front surface includes a headphone jack and a headphone volume. Further, the digital mixer 10 has a back surface equipped with various input/output ports such as a MIC/LINE input port, a LINE-IN input port, an analog output port, a USB connector, an Ethernet connector, and a GPIO port.

The digital mixer 10 includes configuration blocks of an input interface (I/F) 12, an output interface (I/F) 14, a switch 16, an operator 18, a processor 20, a memory 22, and a display 24.

The input I/F 12 includes analog signal input terminals, digital signal input terminals, and analog digital converters (ADCs). The ADCs convert analog audio signals, when they are input, into digital audio signals.

The output I/F 14 includes analog output terminals, digital output terminals, and digital analog converters (DACs). The DACs convert processed digital audio signals into analog audio signals and output the converted signals.

More specifically, the input I/F 12 and the output I/F 14 can be classified into various elements of input port, output port, input/output port, analog audio input/output, digital audio input/output, control input/output, other input/output, and the like. The analog audio input/output consists of MIC/LINE input, LINE input, insert input/output, talkback input, stereo input, LINE output, monitor output, headphone output, and the like. The digital audio input/output consists of USB audio, Dante, and the like. The control input/output consists of GPIO, foot switch, Ethernet, and the like. In this embodiment, there are external operators provided outside. Each external control terminal is a terminal for connecting a corresponding external operator to the main body of the digital mixer, so that the digital mixer can be controlled from the outside by operating the external operator. Further, a part of each of the input I/F 12 and the output I/F 14 corresponds to external control terminals. Both the GPIO and the foot switch can function as external control terminals.

The switch 16 includes various switches that can be operated by users.

The operator 18 includes faders and buttons that can be operated by users to execute various processing on input audio signals. The display 24 may be configured as a touch panel so that a part or the whole of the operator 18 can be displayed on this touch panel to enable touch operations, or the operator 18 may be configured as physical switches, buttons, and knobs. The faders are elements configured to perform input/output level adjustment for audio signals assigned to channel strips, and include linear faders and rotary faders. Here, the channel strip is a unit component that includes faders, knobs, and switches, which are necessary to adjust audio signals of one channel.

The display 24 displays, in response to control signals from the processor 20, setting screens of the digital mixer 10 and the status of each channel module. The display 24 is configured with a liquid crystal panel or an organic EL panel.

The processor 20, which is configured by a CPU or the like, executes various processing by reading and executing processing programs stored in the memory 22. That is, the processor 20 displays various screens on the display 24 in response to operations with the faders and various buttons included in the operator 18, and processes audio signals. Various functions and various parameter values, when they are set by operating the operator 18, are stored in the memory 22 configured by a flash memory or the like. Various signal processing to be executed by the digital mixer 10 can be executed according to the functions and parameters stored in the memory 22.

In the present embodiment, the processor 20 displays a setting screen for setting the AFV function on the display 24. “AFV” refers to a so-called tally link function that automatically controls the fader level in response to an external tally input event. The AFV is settable for each channel. On the setting screen for setting the AFV function, a screen for setting various AFV parameters is displayed. The various parameters include an AFV trigger source.

The processor 20 may include the CPU that controls overall operations for the digital mixer 10 and a digital signal processor (DSP) that executes processing programs based on commands from the CPU to perform input level adjustment, gate processing, equalizing processing, compression processing, mixing processing, effect processing, and the like on audio signals.

The DSP connects input audio signals to input channels. The total number of the input channels is arbitrary. For example, the input channels may be 24 channels of CH 1 to CH 24. In each input channel, level control, gate processing, equalizing processing, compression processing, and the like are executable according to the set parameter values. Audio signals of each input channel are selectively output to a MIX bus, and at the MIX bus the audio signals input from the input channel are subjected to mixing processing. The level of each audio signal output from the input channel to the MIX bus is adjustable. The mixing processed audio signals are output to output channels. The total number of the output channels is arbitrary. For example, the output channels may be 10 channels of MIX1 to MIX10. In the output channel, various processing on the output side is executable according to the set parameter values. Output audio signals from the output channels are output to the output I/F 14.

A user, when setting operations of the digital mixer 10, operates the buttons of the operator 18. According to this button operation, the processor 20 displays on the display 24 a setting screen for setting functions of an external control terminal.

### <Function Setting for External Control Terminal>

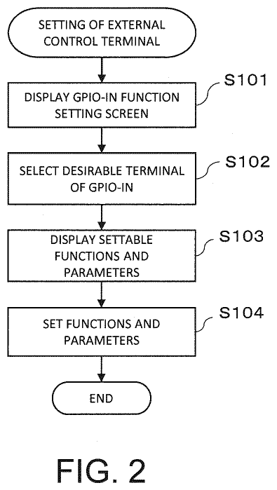

FIG. 2 illustrates a flowchart for setting functions of an external control terminal (e.g., GPIO).

First, the processor 20 displays on the display 24 a menu screen and, when a user's operation on this menu screen is an external control terminal setting mode, displays a setting screen for input (GPIO-IN) of external control terminal (GPIO) (step S101). If there are multiple GPIO-INs, these multiple GPIO-INs are displayed in a list.

A user selects, from the displayed list, a desired GPIO-IN terminal for which functions are to be set (step S102).

The processor 20 displays on the display 24 a setting screen for setting the functions to be set for the selected terminal together with their parameters (step S103). Examples of the functions include Insert, Send, and Mute. The parameters are setting values for respective functions. For example, the parameter for Mute indicates which channel module is to be set to Mute.

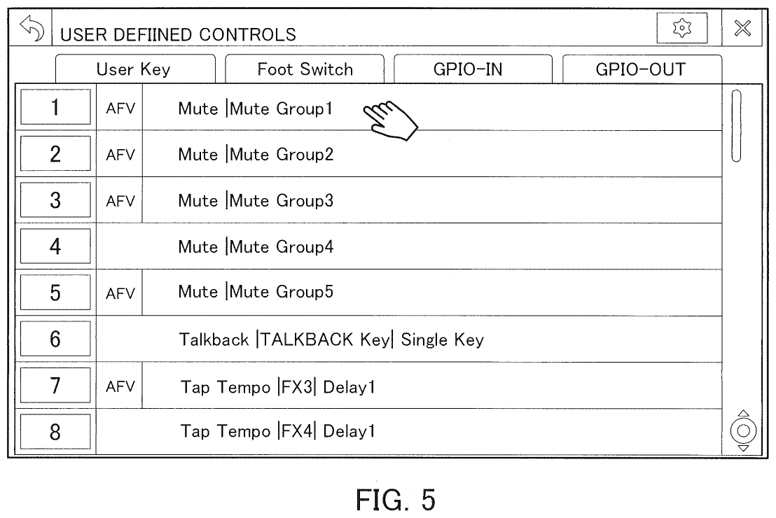

The user uses this setting screen to set the functions together with their parameters for the desired GPIO-IN (step S104). For example, the user sets Mute as a function of the desired GPIO-IN, and sets Mute Group1 as its parameter (see FIG. 5). Here, “Mute Group1” indicates that multiple channels, e.g., three channels of CH 1 to CH 3, are grouped together as one group and muted. The channels consisting of one group can be arbitrarily set by users, and it is also possible to set a single channel.

The processor 20 stores the function(s) set for the GPIO-IN in the memory 22 in association with information (specifically, number) that identifies the GPIO-IN.

Through the above-described processing, the user can set the function of the desired external control terminal using the setting screen displayed on the display 24 by the processor 20.

On the other hand, if the user wishes to set the AFV function on the digital mixer 10, the user selects a channel and then sets the AFV function.

### <Setting of AFV Function>

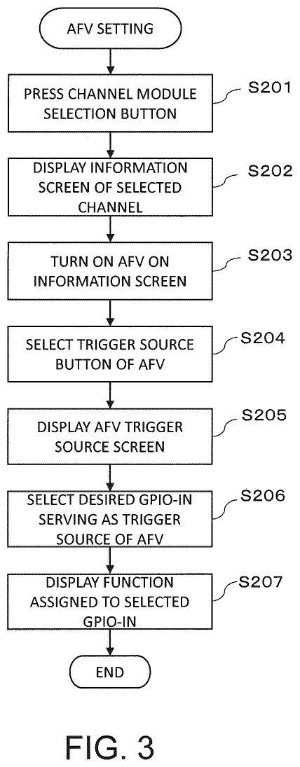

FIG. 3 illustrates a flowchart for setting the AFV function.

The user presses a button of the operator 18, e.g., a channel module selection button (step S201). The processor 20 displays, according to this operation, an information screen of the selected channel on the display 24 (step S202). This information screen displays a status indicating signal processing contents of the selected channel, and displays a switch for setting the AFV function.

When the user operates the AFV function setting switch, an AFV function setting mode is activated, and the user turns on the AFV function on this setting mode screen (step S203). Further, the user sets various parameters of the AFV function. Specifically, the various parameters include, for example:
AFV trigger source;
fade target value of fader level after reception of AFV ON event;
fade target value of fader level after reception of AFV OFF event;
waiting time from reception of AFV ON event until start of fade;
fade time from fade start when receiving AFV ON event until reaching ON level; and
hold time from reception of AFV OFF event until start of fade.

The user selects an AFV trigger source button with the parameter setting screen displayed on the display 24 (step S204).

In response to this operation, the processor 20 displays an AFV trigger source screen on the display 24 (step S205). On the trigger source screen, a list of external control terminals (GPIO-INs) as trigger source candidates is displayed. The user selects an external control terminal (GPIO-IN) to be assigned as an AFV trigger source of the corresponding channel (step S206).

When the user selects the external control terminal (GPIO-IN) serving as the AFV trigger source, the processor 20 stores in the memory 22 the function(s) having been set for the GPIO-IN in association with information (especially, number) identifying the GPIO-IN. The following table 1 shows exemplary settings.

TABLE 1

| GPIO-IN | function 1 | function 2 |
|---|---|---|
| 1 | AFV | Mute |
| 2 | | Mute |
| 3 | | Talkback |

This table shows that both AFV function and Mute function are assigned to GPIO-IN1, only Mute is assigned to GPIO-IN2, and only Talkback is assigned to GPIO-IN3.

The processor 20 highlights the display (e.g., button display) of the selected external control terminal (GPIO-IN) to distinguish it from others, and displays functions already assigned to the corresponding external control terminal in association with the button of the corresponding external control terminal with reference to the information stored in the memory 22, which associates the GPIO-IN with its function (step S207). For example, if the Mute function is already assigned to the external control terminal GPIO-IN1, “Mute” is displayed in association with that button. Therefore, the user can easily and visually check that another function has already been assigned to the external control terminal to which the AFV function is to be assigned.

### <Screen Example>

Next, processing contents of the processor 20 in the present embodiment will be described more specifically with reference to exemplary screens.

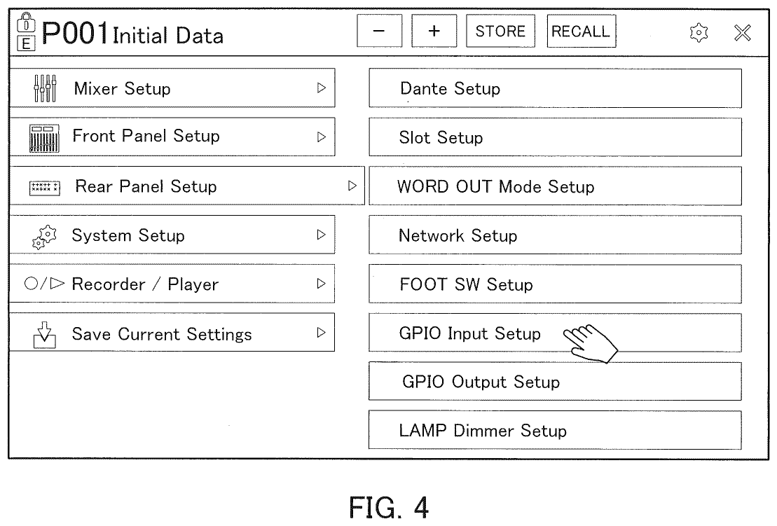

FIG. 4 illustrates an exemplary menu screen that the processor 20 displays on the display 24. This screen is a screen for setting overall functions of the digital mixer 10, and when the user selects and presses “GPIO-Input Setup”, the processor 20 displays on the display 24 a screen for assigning functions to be operated in response to an input from GPIO-IN.

In FIG. 4, “Rear Panel Setup” refers to settings for the already described various input/output ports provided on the back surface of the digital mixer, and GPIO-IN corresponds to one of the external control terminals provided on the back surface.

FIG. 5 illustrates an exemplary setting screen for assigning the function to be operated in response to an input from GPIO-IN. Multiple GPIO-INs are displayed as 1, 2, 3, . . . in a list, and the functions already assigned to respective GPIO-INs are displayed. That is, the processor 20 refers to the information stored in the memory 22, which associates GPIO-INs with their functions, and displays the functions assigned to respective GPIO-INs. For example, in the case of GPIO-IN1 to which AFV and Mute are already assigned, “AFV” and “Mute” are displayed. When multiple functions are assigned, these functions are displayed entirely. Needless to say, if no function has yet been assigned, no function is displayed.

The user, when wishing to newly set or change the function(s) of a desired GPIO-IN, selects a desired GPIO-IN, e.g., GPIO-IN1, on this screen. The processor 20 displays on the display 24 a setting screen for the selected GPIO-IN in response to this operation.

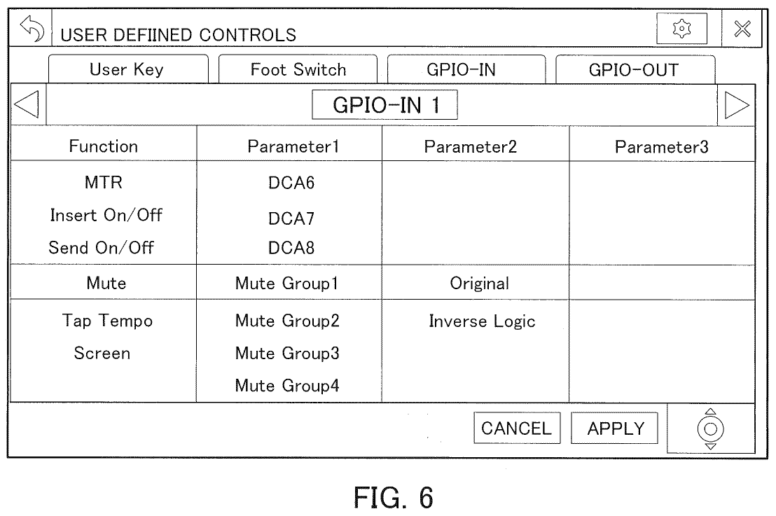

FIG. 6 illustrates an exemplary setting screen for the selected GPIO-IN1. The functions and parameters that can be set for GPIO-IN1 are displayed as a list of multiple columns (four columns in the drawing). In the case of cancelling the Mute function of GPIO-IN1, the operation required in cancellation is pressing “Mute” in the function column. In addition, a lower right part of the exemplary screen is for displaying “CANCEL” and “APPLY” buttons, in which the former button is operable when discarding changed settings and the latter button is operable when confirming the changed settings.

In this embodiment, the screens of FIGS. 5 and 6 correspond to the setting screens for setting functions/parameters of the external control terminal on the display 24. That is, in this embodiment, the setting screens are configured so as to include a screen that displays all the functions already set in the external control terminal and a screen that is displayed when a function of the external control terminal is to be newly set or changed.

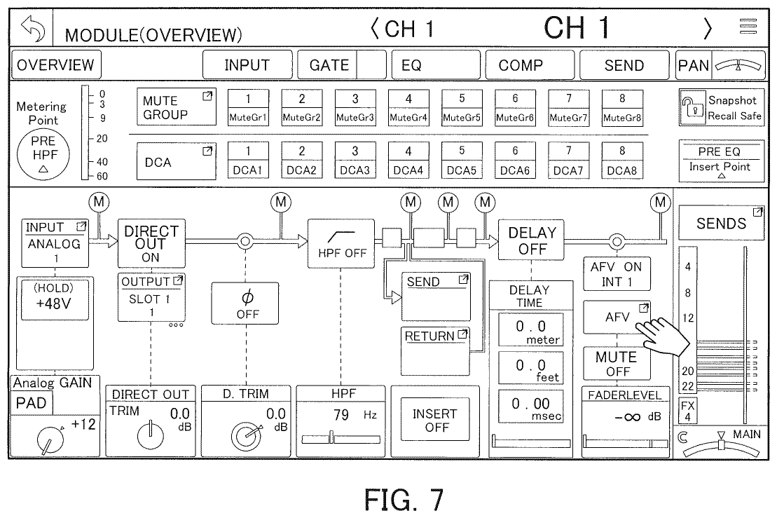

FIG. 7 illustrates an exemplary screen for setting the AFV function in the digital mixer 10. The processor 20 displays on the display 24 an information screen (OVERVIEW) of corresponding channel (e.g., channel 1) in response to a user's operation on the operator 18, for example, pressing of the channel module selection button. This screen includes the display of jump button (labeled “AFV” in the drawing) enabling transition to the screen for setting the AFV function. When the user operates the jump button, the processor 20 displays on the display 24 the screen for setting the AFV function in response to this operation.

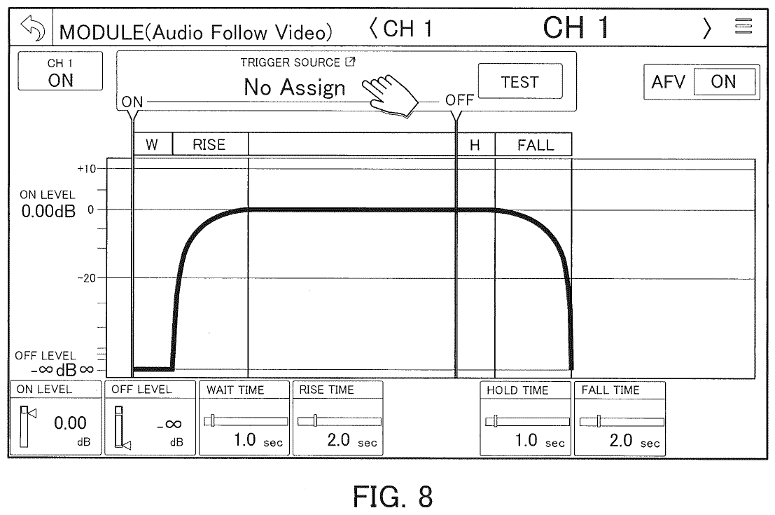

FIG. 8 illustrates an exemplary screen for setting the AFV function, in which various parameters for setting the AFV function are displayed. In the drawing, “CH1 ON” illustrated in an upper left part is a button for setting ON/OFF of AFV function of the channel 1, whose display is highlighted when it is set to ON. Further, “trigger source” illustrated in an upper central part of the screen is a switch for selection of a trigger source of the AFV function, namely a switch for selection of GPIO-IN serving as a trigger for automatically controlling the fader level by a tally input event. When the trigger source has not been set, “No Assign” or the like is displayed as illustrated in the drawing to encourage the user to set it. When the user selects this switch, the processor 20 displays on the display 24 a screen for selecting the trigger source in response to this operation.

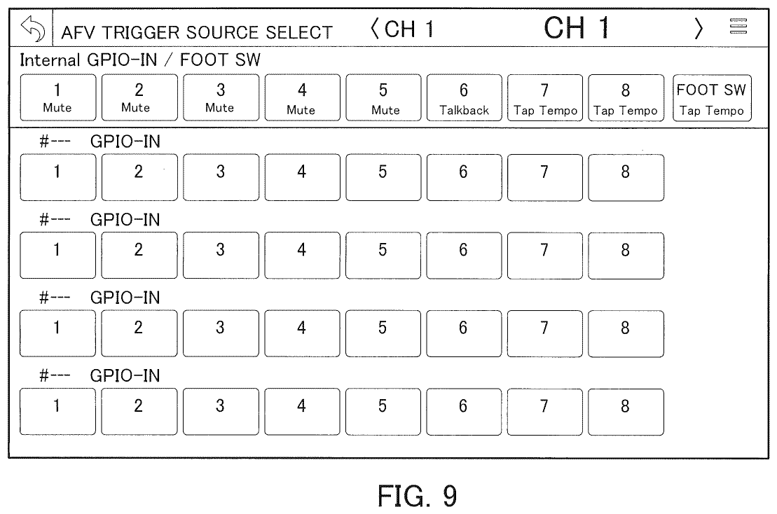

FIG. 9 illustrates an exemplary screen for selecting the trigger source of AFV function. This is a screen for selecting the GPIO-IN to be assigned for the AFV function of the channel selected in FIG. 7. Multiple GPIO-INs are displayed in parallel as 1, 2, 3, . . . in a list. In the drawing, the foot switch (FOOT SW) is also displayed so as to be selectable. When the user selects a desired GPIO-IN serving as the trigger source, the selected GPIO-IN is highlighted and displayed. The drawing shows a case where the user has selected GPIO-IN1. In addition, in the lower row of each GPIO-IN button, the function that has already been set for that GPIO-IN is displayed. For example, in the lower row of GPIO-IN1, “Mute” is displayed to indicate that the Mute function has already been set for the GPIO-IN1. The user, when selecting the GPIO-IN serving as the trigger source of AFV function, can confirm another function having already been set.

When the user selects GPIO-IN1 as the trigger source of AFV function, “GPIO-IN1” is displayed as the trigger source on the screen of FIG. 8. Further, in the setting screen for setting the GPIO-IN function illustrated in FIG. 5, “AFV” is displayed for GPIO-IN1 to indicate the AFV function having been set. That is, in either screen of FIG. 5 and FIG. 9, users can easily and visually check what kinds of functions, including the AFV function, are set for GPIO-INs.

In the present embodiment, the screens of FIGS. 8 and 9 correspond to an AFV trigger source selection screen for selection of ON/OFF of AFV function of each channel and selection of the external control terminal serving as a trigger source of AFV function of each channel. That is, in the present embodiment, the AFV trigger source selection screen is composed of multiple screens whose transition depends on a user's operation.

In the present embodiment, when there is a function already set for GPIO-IN, in the event of newly selecting a trigger source of AFV function for this GPIO-IN, the processor 20 leaves it up to settings by users without displaying or warning anything, even if the already set function and the AFV function are incompatible. The users can determine whether to newly set the trigger source of AFV function by visually checking the function already set, which is displayed in the lower row of the button. An exemplary function that is compatible with the AFV function is, for example, the function of using a built-in player to play a sound source. An exemplary function that is incompatible with the AFV function is, for example, mute.

As described above, in the present embodiment, the processor 20 improves usability for users by displaying multiple functions, including the AFV function, set for the external control terminals in the exemplary screen of FIG. 5 and the exemplary screen of FIG. 9. However, although it is easy to check the GPIO-IN, i.e., the trigger source, to which the AFV function is set in the exemplary screen of FIG. 5, it is impossible to identify at a glance the channel module with which the trigger source is associated. Therefore, as alternative forms of the exemplary screen of FIG. 5, it is preferable to:
(1) display, in the AFV mark, the channel module with which the trigger source is associated; and
(2) if it is the trigger source of multiple channel modules, display a channel module with the smallest number and “. . . ”, and further when this mark is clicked, display a speech bubble near it with the display of all the channel modules assigned thereto.

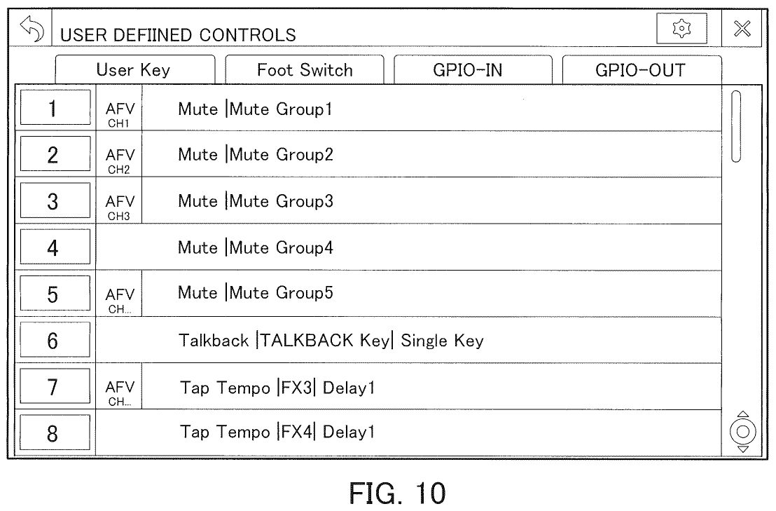

FIG. 10 illustrates an exemplary screen according to the above form (1). The channel number such as “channel 1” is displayed in the “AFV” mark, which makes it possible to easily and visually check the channel module with which the trigger source is associated.

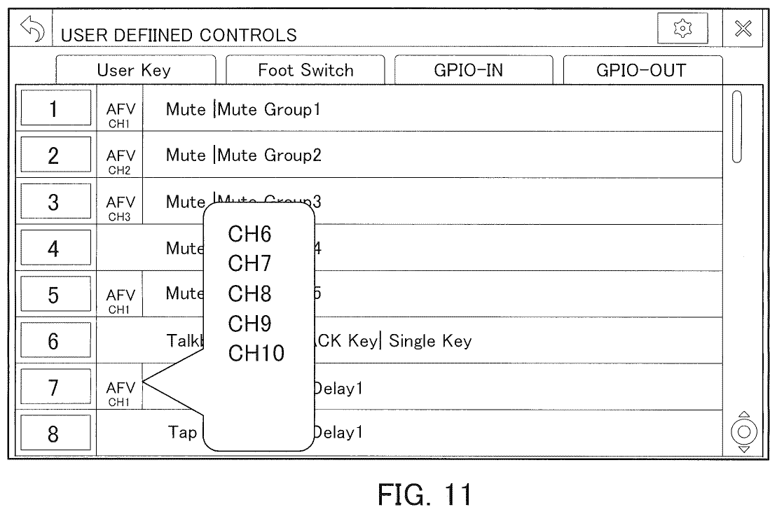

FIG. 11 illustrates an exemplary screen according to the above form (2). When GPIO-IN7 is a trigger source for multiple channel modules, the channel 5 with the smallest number is displayed in the “AFV” mark and also “ . . . ” is displayed. When this is clicked, a speech bubble containing “CH 6, CH 7, CH 8, CH 9, and CH 10” is displayed, and all the channel modules for which GPIO-IN7 is set as the trigger source of AFV function is displayed in a list. By checking this list display, users can easily and visually identify the channel module(s) with which the trigger source is associated.

1. A digital mixer comprising:
an external control terminal;
a processor;
a display device; and
an operator, wherein
the processor causes the display device to display, in response to setting of a setting mode of the external control terminal by the operator, a setting screen for function/parameter setting of the external control terminal;
causes the display device to display, in response to setting of an AFV function setting mode by the operator, an AFV trigger source selection screen for selection of ON/OFF of AFV function of each channel and selection of the external control terminal serving as a trigger source of AFV function of each channel;
displays, on the setting screen, all functions already set for the external control terminal; and
displays, on the AFV trigger source selection screen, the function already set for the external control terminal serving as the AFV trigger source.

2. The digital mixer according to claim 1, wherein the processor displays, on the setting screen, a mark indicating the AFV function together with the function already set when the AFV function is set for the external control terminal, and displays, on the AFV trigger source selection screen, a mark indicating the AFV function together with the function already set when the AFV function is set for the external control terminal serving as the trigger source.

3. The digital mixer according to claim 2, wherein the processor further displays a mark indicating a channel for which the trigger source operates in association with the mark indicating the AFV function on the setting screen.

4. The digital mixer according to claim 3, wherein the processor further displays, when the trigger source is for multiple channels, a list of the multiple channels according to an operation for selecting the mark indicating the AFV function.

5. The digital mixer according to claim 1, wherein the AFV trigger source selection screen includes:
a first screen for setting ON/OFF of the AFV function; and
a second screen for selecting the external control terminal serving as the trigger source of the AFV function.
